(19) United States
(12) Patent Application Publication
(10) Pub. No.: US 2025/0041843 A1
(43) Pub. Date: Feb. 6, 2025

(54) PIPERIDINIUM-CONTAINING POLYMERS

(71) Applicant: Versogen, Inc., Newark, DE (US)

(72) Inventors: Yushan Yan, Hockessin, DE (US); Junhua Wang, Newark, DE (US); Keda Hu, Newark, DE (US); Lan Wang, Newark, DE (US)

(21) Appl. No.: 18/783,818

(22) Filed: Jul. 25, 2024

Related U.S. Application Data
(60) Provisional application No. 63/529,517, filed on Jul. 28, 2023.

(51) Int. Cl. B01J 41/13; H01M 8/10; H01M 8/1023; H01M 8/1072

(52) U.S. Cl. CPC B01J 41/13; H01M 8/1023; H01M 8/1072; H01M 2008/1095

(57) ABSTRACT

Polymers with piperidinium-functionalized groups are provided. The hydroxide (anion) exchange membranes or hydroxide (anion) exchange ionomers formed from these polymers exhibit superior chemical stability, hydroxide conductivity, decreased water uptake, good solubility in selected solvents, and improved mechanical properties upon tuning the polymer structure the combination and ratios of various aromatic and ketone units.

### CROSS-REFERENCE TO RELATED APPLICATIONS

This application claims the benefit of U.S. Provisional Application No. 63/529,517, filed Jul. 28, 2023, which is incorporated by reference herein in its entirety.

### FIELD OF THE INVENTION

Anion exchange polymers and their crosslinked versions capable of forming anion-exchange membranes (AEMs) and ionomers (AEIs) are provided for use in anion exchange membrane devices including fuel cells (FCs), electrolyzers (ELs) and electrodialyzer.

### BACKGROUND OF THE INVENTION

Proton exchange membrane fuel cells (PEMFCs) are considered to be clean and efficient power sources. Steele et al., Nature 2001, 414, 345. However, the high cost and unsatisfactory durability of catalysts are major barriers for large-scale commercialization of PEMFCs. Borup et al., Chem Rev 2007, 107, 3904. By switching the polymer electrolyte from an “acidic” condition to a “basic” one, HEMFCs are able to work with non-precious metal catalysts and the catalysts are expected to be more durable. Other less expensive fuel cell components are also possible such as metal bipolar plates. Varcoe, et al., Fuel Cells 2005, 5, 187; Gu et al., Angew Chem Int Edit 2009, 48, 6499; Gu et al., Chem Commun 2013, 49, 131.

In comparison to Nafion, HEMs have intrinsically lower ionic conductivities under similar conditions, because the mobility of OH− is lower than that of H+. Hibbs et al., Chem Mater 2008, 20, 2566. Greater ion-exchange capacity (IEC) is needed for HEMs/HEIs to achieve greater hydroxide conductivity. However, high IEC usually leads to a membrane having high water uptake (i.e., a high swelling ratio), decreasing the morphological stability and mechanical strength of the membrane, especially after repeated wet-dry cycles. This highly swollen state when wet is a major reason for decreased flexibility and brittleness of HEMs when dry. The removal of the trade-off between high hydroxide conductivity and low water uptake has been a major setback in designing high-performance HEMs/HEIs. Pan et al., Energ Environ Sci 2013, 6, 2912. Chemical cross-linking, physical reinforcement, side-chain polymerization, and block-copolymer architecture have been tried to reduce water uptake while maintaining acceptable hydroxide conductivity, but these techniques bring challenging problems, e.g., reduced mechanical flexibility, decreased alkaline stability, and/or increased cost. Gu et al., Chem Commun 2011, 47, 2856; Park et al., Electrochem Solid St 2012, 15, B27; Wang et al., Chemsuschem 2015, 8, 4229; Ran et al., Sci Rep-Uk 2014, 4; Tanaka et al., J Am Chem Soc 2011, 133, 10646. Additionally, almost all side-chain or block-copolymer HEMs are based on flexible aliphatic polymer chains due to limited available synthesis methods. As a result, the membranes still cannot provide morphological stability (low swell ratio) at high IECs and high temperature. Wang et al., Chemsuschem 2015, 8, 4229; Ran et al., Sci Rep-Uk 2014, 4; Marino et al., Chemsuschem 2015, 8, 513; Li et al, M. Macromolecules 2015, 48, 6523.

An additional obstacle to using HEMs is achievement of mechanical flexibility and strength in an ambient dry state. Most HEMs exhibit low mechanical strength and are very brittle in a completely dry state especially after being completely swollen. It is difficult to obtain and handle thin membranes that are large in size as needed for commercial use of HEMs. Without good mechanical properties, the ionomers cannot form and keep an adequate triple phase structure in the fuel cell electrode at high temperature, such as at or above 80° C. Li et al., J Am Chem Soc 2013, 135, 10124.

PEMFCs have recently been deployed as zero-emission power sources in commercially sold automobiles, with demonstrated long driving range and short refueling time, which are two features preferred for customer acceptance. However, PEMFCs use platinum electrocatalysts and are not yet cost competitive with gasoline engines. Major approaches to PEMFC cost reduction include development of low-platinum-loading, high power density membrane electrode assemblies (MEAs), and platinum-group-metal-free (PGM-free) cathode catalysts. A fundamentally different pathway to low-cost fuel cells is to switch from PEMFCs to hydroxide exchange membrane fuel cells (HEMFCs) that, due to their basic operating environment, can work with PGM-free anode and cathode catalysts, and thus are potentially economically viable. To replace PEMFCs, however, HEMFCs have to provide a performance that matches PEMFCs, performance which in turn requires highly active anode and cathode catalysts as well as the highly chemically stable, ionically conductive.

A series of piperidinium-functionalized anion exchange polymers are prepared. Both crosslinked and non-crosslinked anion exchange membranes (hydroxide exchange membranes) based on these anion exchange polymers showed excellent alkaline stability. The mechanical strength, water uptake, swelling ratio and conductivity of the membranes could be fine-tuned by combinations of various aromatic monomers, ketone monomers as well as the degree of crosslinking and the crosslinking reagents in the polymers.

### SUMMARY OF THE INVENTION

The first aspect of the invention is directed to an anion exchange polymer which comprises structural units of formulae 1A, at least two of formulae 2A, 2A-2, 3A, or 3A-2, and one of formulae 4A, 5A, 5A-2 or 6A. A sum of mole fractions of the structural units of formulae 1A and 4A or 5A or 5A-2 or 6A is equal to a sum of mole fraction of formula 2A, 2A-2, 3A, and 3A-2 in the polymer calculated from an amount of monomers used in a polymerization reaction to form the polymer, and a mole ratio of the structural unit of Formula 1A to the structural unit of Formula 4A or 5A or 5A-2 or 6A is from 0.01 to 100 calculated from the amount of monomers used in the polymerization reaction, and a mole ratio between the structural units of formulae of 2A, 2A-2, 3A, and 3A-2 is from 0.01 to 100 calculated from the amount of monomers used in the polymerization reaction. The structural units of Formulae 1A, 2A, 2A-2, 3A, 3A-2 4A, 5A, 5A-2 and 6A have the structures:

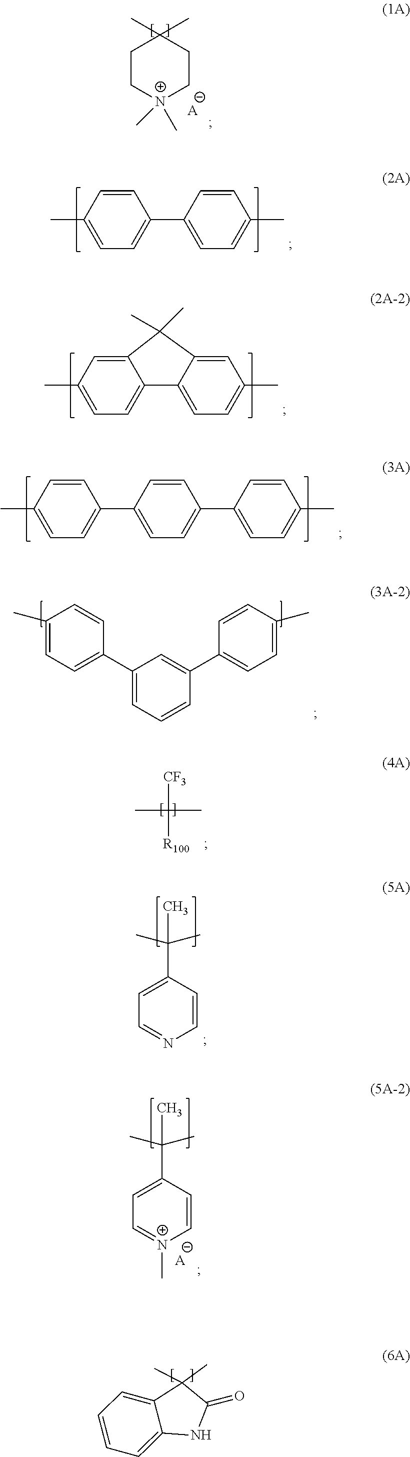

wherein:
A⁻ is an anion;
R₁₀₀ is independently alkyl, alkenyl, alkynyl, or

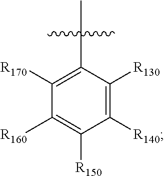

and
R₁₃₀, R₁₄₀, R₁₅₀, R₁₆₀ and R₁₇₀ are each independently hydrogen, halide, alkyl, alkenyl, alkynyl or aryl, and the alkyl, alkenyl, alkynyl or aryl are optionally substituted with halide.

The second aspect of the invention is directed to an anion exchange polymer which comprises structural units of formulae 1A, at least two of 2A, 2A-2, 3A, or 3A-2, and at least two of 4A, 5A, 5A-2, or 6A. A sum of mole fractions of the structural units of formulae 1A, 4A, 5A, 5A-2 and 6A is equal to a sum of mole fraction of formula 2A, 2A-2, 3A, and 3A-2 in the polymer calculated from an amount of monomers used in a polymerization reaction to form the polymer, and a mole ratio of the structural unit of Formula 1A to a sum of mole fraction of Formula 4A, 5A, 5A-2 and 6A is from 0.01 to 100 calculated from the amount of monomers used in the polymerization reaction, and a mole ratio between the structural unit of formula of 2A, 2A-2, 3A, and 3A-2 is from 0.01 to 100 calculated from the amount of monomers used in the polymerization reaction. The structural units of Formulae 1A, 2A, 2A-2, 3A, 3A-2 4A, 5A, 5A-2 and 6A have the structures:

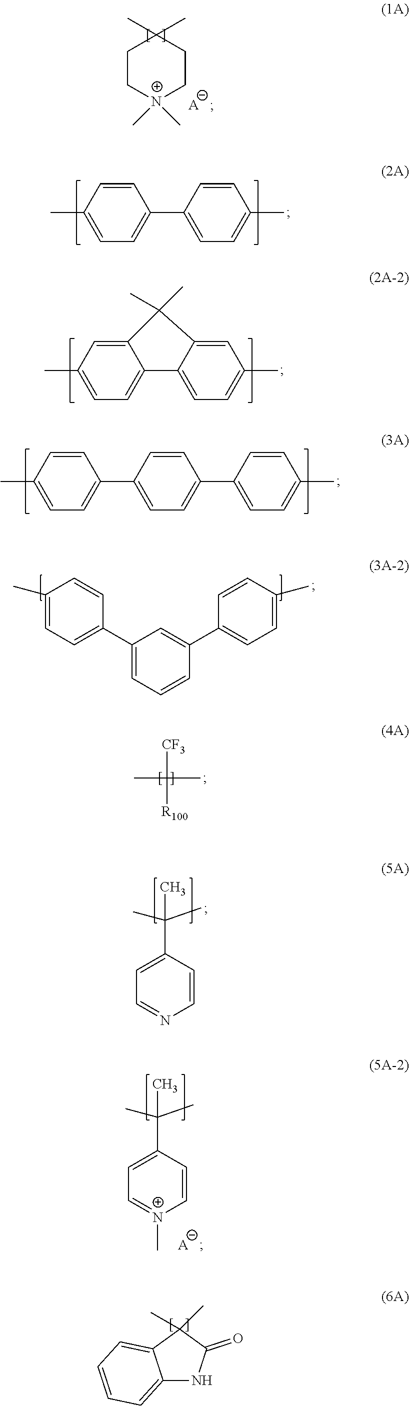

wherein:
A⁻ is an anion;
R₁₀₀ is independently alkyl, alkenyl, alkynyl, or

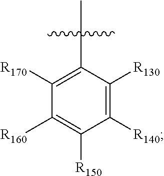

and
R₁₃₀, R₁₄₀, R₁₅₀, R₁₆₀ and R₁₇₀ are each independently hydrogen, halide, alkyl, alkenyl, alkynyl or aryl, and the alkyl, alkenyl, alkynyl or aryl are optionally substituted with halide.

The third aspect of the invention is directed to an anion exchange polymer comprising a reaction product of a polymerization mixture comprising: a piperidone monomer or salt or hydrate thereof of formula 1, at least two of aromatic monomers of formulae 2, 2-2, 3, or 3-2, and one of the ketone monomers of formula 4, 5, or 6. The piperidone monomer or salt or hydrate thereof has the formula:

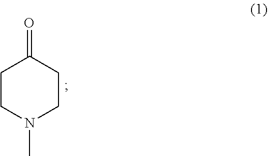

the aromatic monomers have the formula:

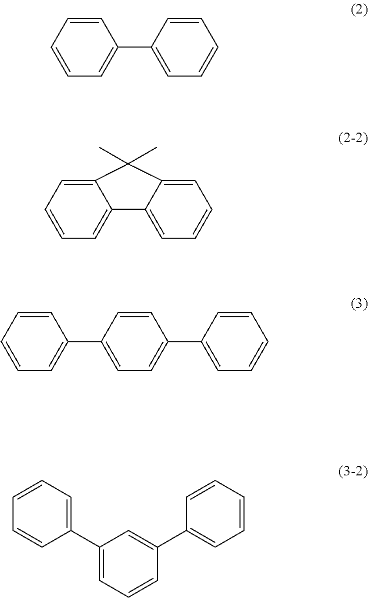

the ketone monomers have the formula:

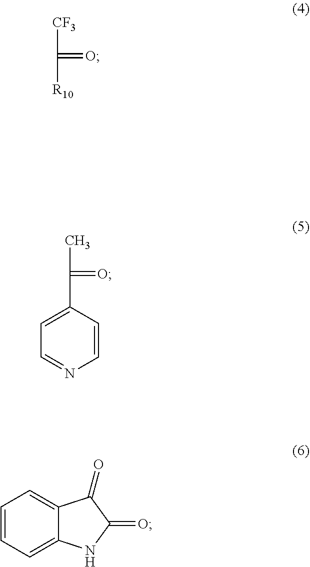

wherein:
R₁₀ is independently alkyl, alkenyl, alkynyl, or

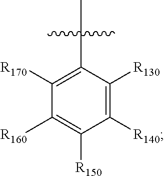

and
R₁₃₀, R₁₄₀, R₁₅₀, R₁₆₀ and R₁₇₀ are each independently hydrogen, halide, alkyl, alkenyl, alkynyl or aryl, and the alkyl, alkenyl, alkynyl or aryl are optionally substituted with halide.

The fourth aspect of the invention is directed to an anion exchange polymer comprising a reaction product of a polymerization mixture comprising: a piperidone monomer or salt or hydrate thereof of formula 1, at least two of aromatic monomers of formula 2, 2-2, 3, or 3-2, and at least two of the ketone monomers of formula 4, 5, or 6.

The piperidone monomer or salt or hydrate thereof has the formula:

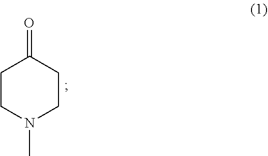

the aromatic monomers have the formula:

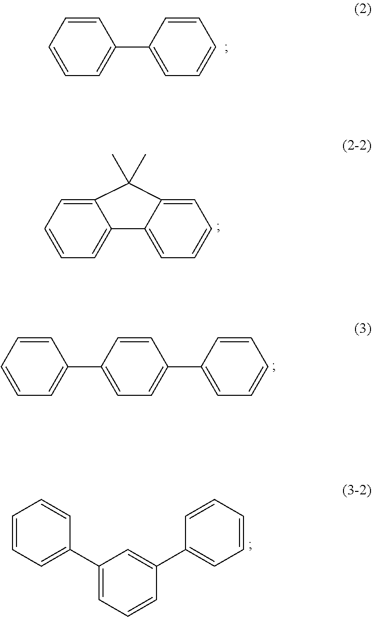

the ketone monomers have the formula:

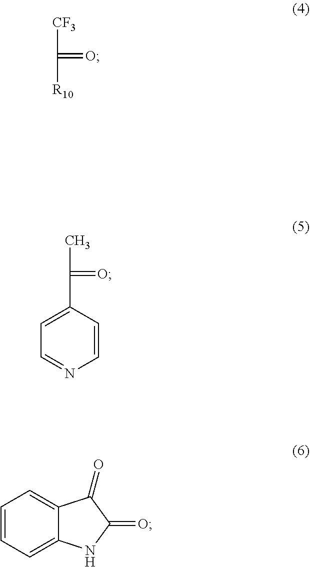

wherein:
R₁₀ is independently alkyl, alkenyl, alkynyl, or

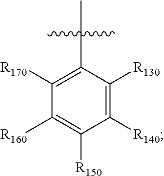

and
R₁₃₀, R₁₄₀, R₁₅₀, R₁₆₀ and R₁₇₀ are each independently hydrogen, halide, alkyl, alkenyl, alkynyl or aryl, and the alkyl, alkenyl, alkynyl or aryl are optionally substituted with halide.

The fifth aspect of the invention is a neutralized polymer comprising a reaction product of a base and the polymer of one of the third and fourth aspects of the invention.

The sixth aspect of the invention is an alkylated or alkylated polymer which comprises a reaction product of a mixture comprising: an alkylating reagent and the neutralized polymer in the fifth aspect of the invention.

An anion exchange membrane is also provided, optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO₂ separator, and the anion exchange membrane comprising any of the polymers as described above.

An anion exchange membrane fuel cell, electrolyzer, electrodialyzer, solar hydrogen generator, flow battery, desalinator, sensor, demineralizer, water purifier, waste water treatment system, ion exchanger, or CO₂ separator is also provided, the fuel cell, electrolyzer, electrodialyzer, solar hydrogen generator, flow battery, desalinator, sensor, demineralizer, water purifier, waste water treatment system, ion exchanger, or CO₂ separator is provided, comprising any of the anion exchange polymers as described above.

Also provided is a reinforced electrolyte membrane, optionally configured and sized to be suitable for use in a fuel cell, electrolyzer, electrodialyzer, solar hydrogen generator, flow battery, desalinator, sensor, demineralizer, water purifier, wastewater treatment system, ion exchanger, or CO₂ separator. The membrane comprises a porous substrate impregnated with any of the polymers as described above.

A method of making an anion exchange polymer as described above is provided. The method comprises: reacting the piperidone monomer with the aromatic monomers, the ketone monomer(s) in the presence of an organic solvent and a polymerization catalyst to form an acidified intermediate polymer; reacting the acidified intermediate polymer with a base to form a neutralized polymer; alkylating the neutralized polymer in the presence of an organic solvent to form a piperidinium-functionalized polymer; and reacting the piperidinium-functionalized polymer with halide, hydroxide, bicarbonate, or carbonate ions or a combination thereof to form the anion exchange polymer.

A method of making an anion exchange membrane is provided. The method comprises: reacting the piperidone monomer with the aromatic monomers, the ketone monomer(s) in the presence of an organic solvent and a polymerization catalyst to form an acidified intermediate polymer; reacting the acidified intermediate polymer with a base to form a neutralized polymer; alkylating the neutralized polymer in the presence of an organic solvent to form a piperidinium-functionalized polymer; and reacting the piperidinium-functionalized polymer with halide, hydroxide, bicarbonate, or carbonate ions or a combination thereof to form the anion exchange polymer; dissolving the anion exchange polymer in a solvent to form a polymer suspension or solution; and casting the polymer suspension or solution to form the anion exchange polymer membrane.

A method of making a crosslinked anion exchange polymer comprising the anion exchange polymer as described above is provided. The method comprises: reacting the piperidone monomer with the aromatic monomers, the ketone monomer(s) in the presence of an organic solvent and a polymerization catalyst to form an acidified intermediate polymer; reacting the acidified intermediate polymer with a base to form a neutral piperidine-functionalized polymer; partially alkylating the neutral piperidine-functionalized polymer with an alkylating agent to form a partially alkylated piperidinium-functionalized polymer having piperidine groups available for crosslinking; reacting the partially alkylated piperidinium-functionalized polymer with a crosslinking reagent to form a crosslinked polymer; exchanging anions of the crosslinked polymer with halide, hydroxide, bicarbonate, or carbonate ions or a combination thereof to form the crosslinked anion exchange polymer; and optionally reacting the crosslinked anion exchange polymer with trimethyl amine to alkylate partially reacted crosslinking reagent.

A method of making a crosslinked anion exchange membrane comprising the anion exchange polymer as described above is provided. The method comprises: reacting the piperidone monomer with the aromatic monomers, the ketone monomer(s) in the presence of an organic solvent and a polymerization catalyst to form an acidified intermediate polymer; reacting the acidified polymer with a base to form a neutral piperidine-functionalized polymer; partially alkylating the neutral piperidine-functionalized polymer with an alkylating agent to leave part of the neutral piperidine intact for crosslinking; exchanging anions of the piperidinium-functionalized polymer with hydroxide, bicarbonate, or carbonate ions or a combination thereof to form an anion exchange polymer; dissolving the ion exchange polymer in a solvent to form a polymer suspension or solution; adding a crosslinking reagent to the polymer suspension or solution and casting to form the crosslinked anion exchange polymer membrane; and optionally reacting the crosslinked anion exchange polymer membrane with trimethyl amine to alkylate partially reacted crosslinking reagent.

Other objects and features will be in part apparent and in part pointed out hereinafter.

### BRIEF DESCRIPTION OF THE DRAWINGS

FIG. 1A illustrates an exemplary hydroxide exchange membrane fuel cell.

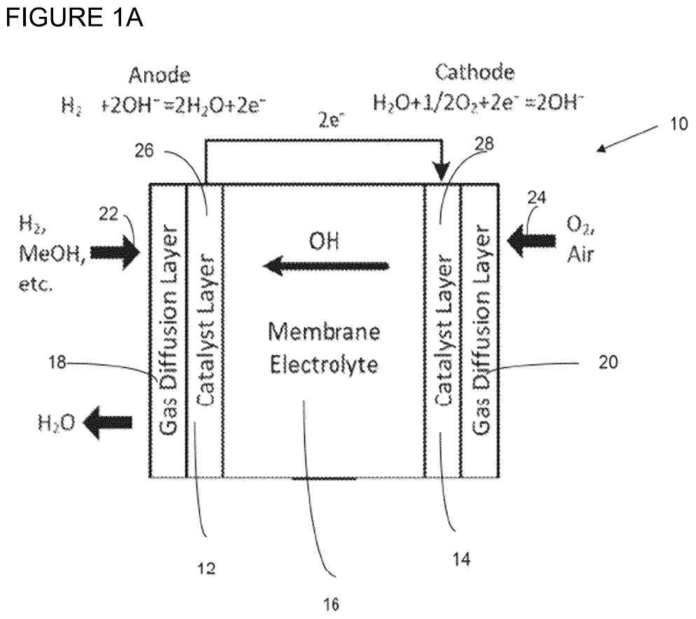

FIG. 1B illustrates an exemplary hydroxide exchange membrane electrolyzer.

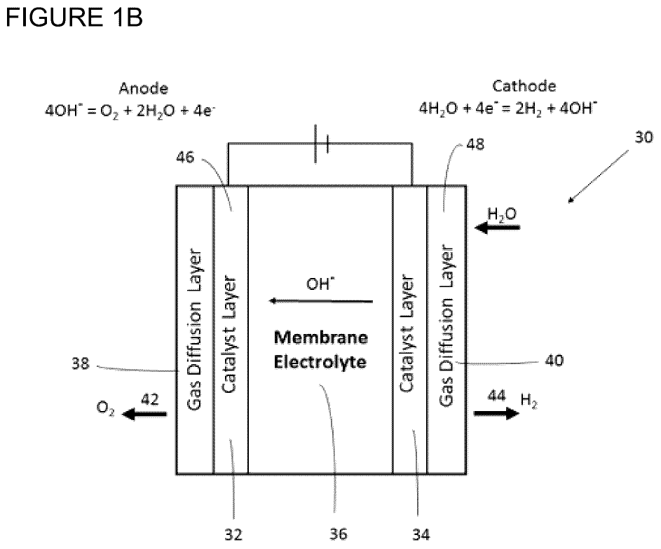

FIG. 2 depicts an 1H NMR spectrum of P1-Neutral-0.85 in CDCl₃

FIG. 3 depicts an 1H NMR spectrum of P1-Me-0.85 in DMSO-d6.

### DESCRIPTION OF THE PREFERRED EMBODIMENTS

HEMs/HEIs formed from poly(aryl alkylene) polymers with various pendant piperidinium-functionalized groups and having intrinsic hydroxide conduction channels have been discovered which simultaneously provide improved chemical stability, conductivity, water uptake, good solubility in selected solvents, mechanical properties, and other attributes relevant to HEM/HEI performance. HEMs/HEIs formed from these polymers exhibit superior chemical stability, anion conductivity, decreased water uptake, good solubility in selected solvents, and improved mechanical properties in an ambient dry state as compared to conventional HEM/HEIs. The inventive HEMFCs exhibit enhanced performance and durability at relatively high temperatures.

The first aspect of the invention is directed to an anion exchange polymer which comprises structural units of formulae 1A, at least two of 2A, 2A-2, 3A, 3A-2, and one of 4A, 5A, 5A-2, 6A. A sum of mole fractions of the structural units of formulae 1A and 4A or 5A or 5A-2 or 6A is equal to a sum of mole fraction of formula 2A, 2A-2, 3A, 3A-2 in the polymer calculated from an amount of monomers used in a polymerization reaction to form the polymer, and a mole ratio of the structural unit of Formula 1A to the structural unit of Formula 4A or 5A or 5A-2 or 6A is from 0.01 to 100 calculated from the amount of monomers used in the polymerization reaction, and a mole ratio between the structural unit of formula of 2A, 2A-2, 3A, 3A-2 is from 0.01 to 100 calculated from the amount of monomers used in the polymerization reaction. The structural units of Formulae 1A, 2A, 2A-2, 3A, 3A-2 4A, 5A, 5A-2 and 6A have the structures:

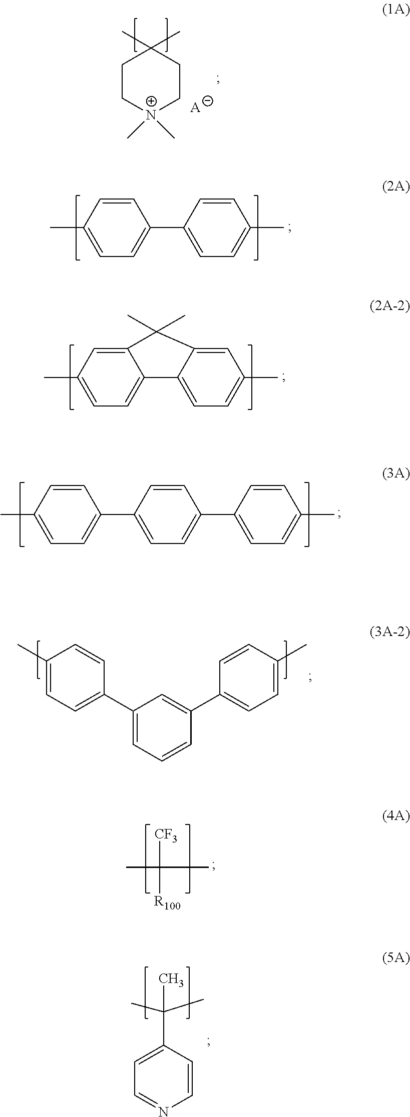

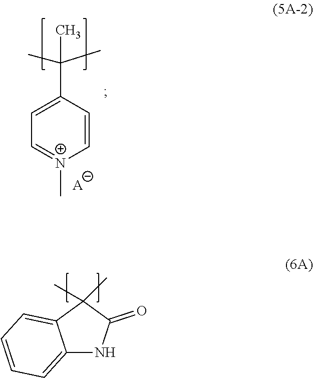

wherein:
A⁻ is an anion;
R₁₃₀, R₁₄₀, R₁₅₀, R₁₆₀ and R₁₇₀ are each independently hydrogen, halide, alkyl, alkenyl, alkynyl or aryl, and the alkyl, alkenyl, alkynyl or aryl are optionally substituted with halide;
R₁₀₀ is independently alkyl, alkenyl, alkynyl, or

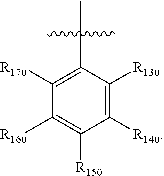

The second aspect of the invention is directed to an anion exchange polymer which comprises structural units of formulae 1A, at least two of 2A, 2A-2, 3A, 3A-2, and at least two of 4A, 5A, 5A-2, 6A. A sum of mole fractions of the structural units of formulae 1A, 4A, 5A, 5A-2 and 6A is equal to a sum of mole fraction of formula 2A, 2A-2, 3A, 3A-2 in the polymer calculated from an amount of monomers used in a polymerization reaction to form the polymer, and a mole ratio of the structural unit of Formula 1A to a sum of mole fraction of Formula 4A, 5A, 5A-2 and 6A is from 0.01 to 100 calculated from the amount of monomers used in the polymerization reaction, and a mole ratio between the structural unit of formula of 2A, 2A-2, 3A, 3A-2 is from 0.01 to 100 calculated from the amount of monomers used in the polymerization reaction. The structural units of Formulae 1A, 2A, 2A-2, 3A, 3A-2 4A, 5A, 5A-2 and 6A have the structures:

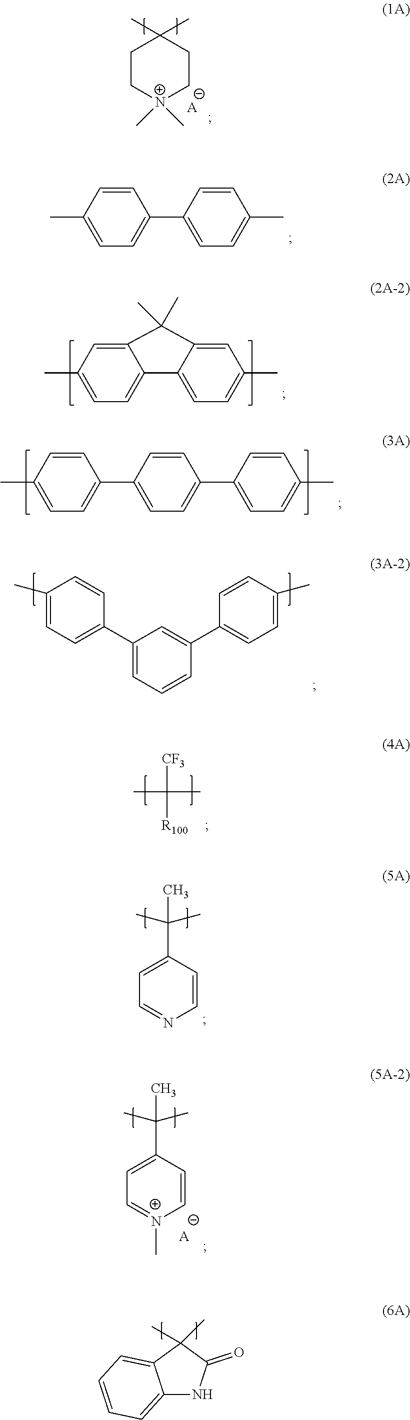

wherein:
A⁻ is an anion;
R₁₃₀, R₁₄₀, R₁₅₀, R₁₆₀ and R₁₇₀ are each independently hydrogen, halide, alkyl, alkenyl, alkynyl or aryl, and the alkyl, alkenyl, alkynyl or aryl are optionally substituted with halide;
R₁₀₀ is independently alkyl, alkenyl, alkynyl, or

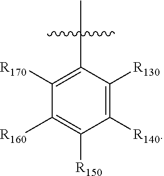

The third aspect of the invention is directed to an anion exchange polymer comprising a reaction product of a polymerization mixture comprising: a piperidone monomer or salt or hydrate thereof of formula 1, at least two of aromatic monomers of formula 2, 2-2, 3, 3-2, and one of the ketone monomers of formula 4, 5, 6.

The piperidone monomer or salt or hydrate thereof has the formula:

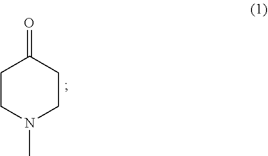

the aromatic monomers have the formula:

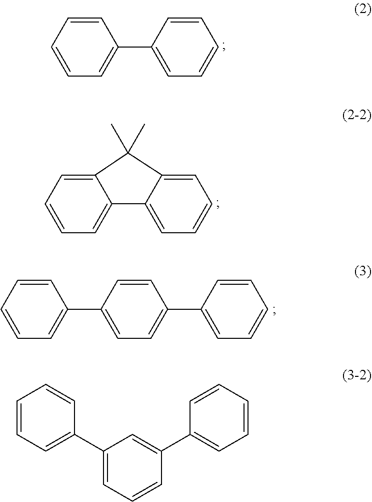

the ketone monomers have the formula:

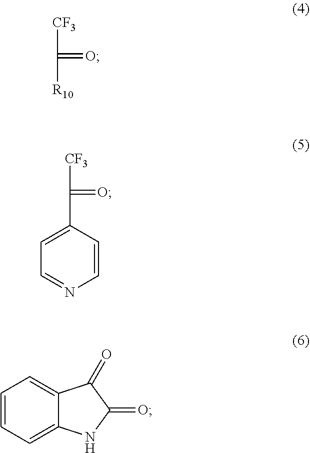

wherein:
R₁₃₀, R₁₄₀, R₁₅₀, R₁₆₀ and R₁₇₀ are each independently hydrogen, halide, alkyl, alkenyl, alkynyl or aryl, and the alkyl, alkenyl, alkynyl or aryl are optionally substituted with halide;
R₁₀ is independently alkyl, alkenyl, alkynyl, or

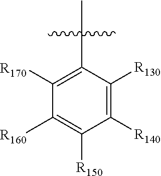

The fourth aspect of the invention is directed to an anion exchange polymer comprising a reaction product of a polymerization mixture comprising: a piperidone monomer or salt or hydrate thereof of formula 1, at least two of aromatic monomers of formula 2, 2-2, 3, 3-2, and at least two of the ketone monomers of formula 4, 5, 6.

The piperidone monomer or salt or hydrate thereof has the formula:

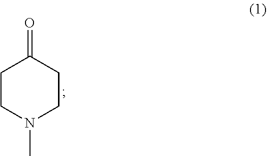

the aromatic monomers have the formula:

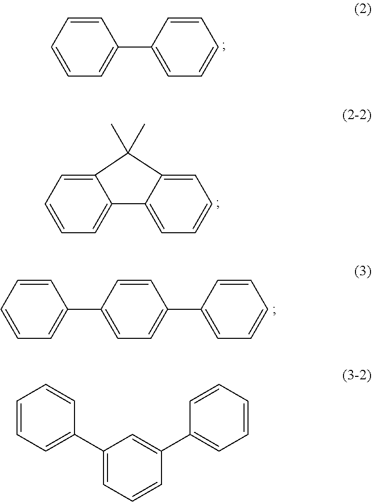

the ketone monomers have the formula:

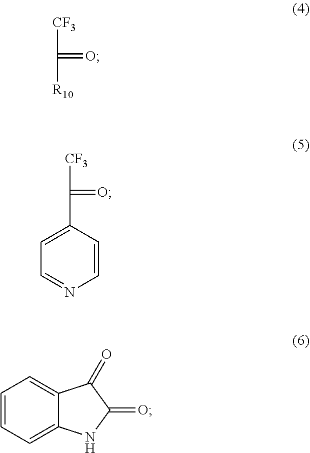

wherein:
R₁₃₀, R₁₄₀, R₁₅₀, R₁₆₀ and R₁₇₀ are each independently hydrogen, halide, alkyl, alkenyl, alkynyl or aryl, and the alkyl, alkenyl, alkynyl or aryl are optionally substituted with halide;
R₁₀ is independently alkyl, alkenyl, alkynyl, or

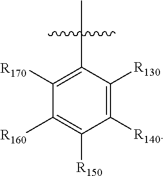

The fifth aspect of the invention is a polymer which comprises a second reaction product of a second polymerization mixture comprising: a base, an alkylating reagent and an intermediate polymer; wherein the intermediate polymer comprises a first reaction product of a first polymerization mixture comprising: the piperidone monomer or salt or hydrate thereof having the formula (1); at least two of the aromatic monomers having the formula 2, 2-2, 3, 3-2; one of the ketone monomers having the formula 4, 5, 6. (i.e., the first polymerization mixture comprises the monomers of the third aspect of the invention).

The sixth aspect of the invention is a polymer which comprises a second reaction product of a second polymerization mixture comprising: a base, an alkylating reagent and an intermediate polymer; wherein the intermediate polymer comprises a first reaction product of a first polymerization mixture comprising: the piperidone monomer or salt or hydrate thereof having the formula (1); at least two of the aromatic monomers having the formula 2, 2-2, 3, 3-2; at least two of the ketone monomers having the formula 4, 5, 6. (i.e., the first polymerization mixture comprises the monomers of the fourth aspect of the invention).

The seventh aspect of the invention is a neutralized polymer comprising a reaction product of a base and the polymer of one of the third and fourth aspects of the invention. Another alkylated polymer is provided, the alkylated polymer comprising a reaction product of an alkylating agent and the neutralized polymer. Another polymer comprises the reaction product of a base and the alkylated polymer.

An anion exchange membrane is also provided, optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO₂ separator, and the anion exchange membrane comprising any of the anion exchange polymers as described above.

An anion exchange membrane fuel cell, electrolyzer, electrodialyzer, solar hydrogen generator, flow battery, desalinator, sensor, demineralizer, water purifier, waste water treatment system, ion exchanger, or CO₂ separator is also provided, the fuel cell, electrolyzer, electrodialyzer, solar hydrogen generator, flow battery, desalinator, sensor, demineralizer, water purifier, waste water treatment system, ion exchanger, or CO₂ separator is provided, comprising any of the anion exchange polymers as described above.

Also provided is a reinforced electrolyte membrane, optionally configured and sized to be suitable for use in a fuel cell, electrolyzer, electrodialyzer, solar hydrogen generator, flow battery, desalinator, sensor, demineralizer, water purifier, wastewater treatment system, ion exchanger, or CO₂ separator. The membrane comprises a porous substrate impregnated with any of the anion exchange polymers as described above.

A method of making an anion exchange polymer as described above is provided. The method comprises: reacting the piperidone monomer with the aromatic monomers, the ketone monomer(s) in the presence of an organic solvent and a polymerization catalyst to form an acidified intermediate polymer; reacting the acidified intermediate polymer with a base to form a neutralized polymer; alkylating the neutralized intermediate polymer in the presence of an organic solvent to form a piperidinium-functionalized polymer; and reacting the piperidinium-functionalized polymer with halide, hydroxide, bicarbonate, or carbonate ions or a combination thereof to form the anion exchange polymer.

A making an anion exchange membrane is provided. The method comprises: reacting the piperidone monomer with the aromatic monomers, the ketone monomer(s) in the presence of an organic solvent and a polymerization catalyst to form an acidified intermediate polymer; reacting the acidified intermediate polymer with a base to form a neutralized polymer; alkylating the neutralized intermediate polymer in the presence of an organic solvent to form a piperidinium-functionalized polymer; and reacting the piperidinium-functionalized polymer with halide, hydroxide, bicarbonate, or carbonate ions or a combination thereof to form the anion exchange polymer; dissolving the anion exchange polymer in a solvent to form a polymer suspension or solution; and casting the polymer suspension or solution to form the anion exchange polymer membrane.

A method of making a crosslinked anion exchange polymer comprising the anion exchange polymer as described above is provided. The method comprises: reacting the piperidone monomer with the aromatic monomers, the ketone monomer(s) in the presence of an organic solvent and a polymerization catalyst to form an acidified intermediate polymer; reacting the acidified intermediate polymer with a base to form a neutral piperidine-functionalized polymer; partially alkylating the neutral piperidine-functionalized polymer with an alkylating agent to form a partially alkylated piperidinium-functionalized polymer having piperidine groups available for crosslinking; reacting the partially alkylated piperidinium-functionalized polymer with a crosslinking reagent to form a crosslinked polymer; exchanging anions of the crosslinked polymer with halide, hydroxide, bicarbonate, or carbonate ions or a combination thereof to form the crosslinked anion exchange polymer; and optionally reacting the crosslinked anion exchange polymer with trimethyl amine to alkylate partially reacted crosslinking reagent.

A method of making a crosslinked anion exchange membrane comprising the anion exchange polymer as described above is provided. The method comprises: reacting the piperidone monomer with the aromatic monomers, the ketone monomer(s) in the presence of an organic solvent and a polymerization catalyst to form an acidified intermediate polymer; reacting the acidified polymer with a base to form neutral piperidine-functionalized polymer; partially alkylating the neutral piperidine-functionalized polymer with an alkylating agent to leave part of the neutral piperidine intact for crosslinking; exchanging anions of the piperidinium-functionalized polymer with hydroxide, bicarbonate, or carbonate ions or a combination thereof to form an anion exchange polymer; dissolving the ion exchange polymer in a solvent to form a polymer suspension or solution; adding a crosslinking reagent to the polymer suspension or solution and casting to form the crosslinked anion exchange polymer membrane; and optionally reacting the crosslinked anion exchange polymer membrane with trimethyl amine to alkylate partially reacted crosslinking reagent.

The salt of the piperidone monomer can comprise hydrochloride, hydrofluoride, hydrobromide, hydroiodide, trifluoroacetate, acetate, triflate, methanesulfonate, sulfate, nitrate, tetrafluoroborate, hexafluorophosphate, formate, benzenesulfonate, toluate, perchlorate, or benzoate, or any hydrate of the salt, or any combination thereof.

The salt of the piperidone monomer can comprise N-methyl-4-piperidone hydrofluoride, N-methyl-4-piperidone hydrochloride, N-methyl-4-piperidone hydrobromide, N-methyl-4-piperidone hydroiodide, N-methyl-4-piperidone trifluoroacetate, N-methyl-4-piperidone tetrafluoroborate, N-methyl-4-piperidone hexafluorophosphate, N-methyl-4-piperidone acetate, N-methyl-4-piperidone triflate, N-methyl-4-piperidone methanesulfonate, N-methyl-4-piperidone formate, N-methyl-4-piperidone benzenesulfonate, N-methyl-4-piperidone toluate, N-methyl-4-piperidone sulfate, N-methyl-4-piperidone nitrate, N-methyl-4-piperidone perchlorate, N-methyl-4-piperidone benzoate or any hydrate of the salt, or any combination thereof.

The anion A⁻ of the structural units 1A or 5A-2 can comprise a halide, carbonate, bicarbonate, hydroxide, trifluoroacetate, acetate, triflate, methanesulfonate, sulfate, nitrate, tetrafluoroborate, hexafluorophosphate, formate, benzenesulfonate, toluate, perchlorate, or benzoate or any combination thereof.

The polymerization catalyst used in any of the methods described herein can comprise trifluoromethanesulfonic acid, pentafluoroethanesulfonic acid, heptafluoro-1-propanesulfonic acid, trifluoroacetic acid, perfluoropropionic acid, heptafluorobutyric acid, or a combination thereof.

Each of the organic solvents used in the any of the above methods can be independently selected from polar aprotic solvents (e.g., dimethyl sulfoxide, 1-methyl-2-pyrrolidone, dimethylacetamide, or dimethylformamide) or other suitable solvents including, but not limited to, methylene chloride, trifluoroacetic acid, trifluoromethanesulfonic acid, chloroform, 1,1,2,2-tetrachloroethane, dimethylacetamide or a combination thereof.

The solvent in the dissolving step of any of the above methods can comprise methanol, ethanol, n-propanol, isopropanol, n-butanol, sec-butanol, tert-butanol, a pentanol, a hexanol, dimethyl sulfoxide, 1-methyl-2-pyrrolidone, dimethylformamide, dimethylacetamide, chloroform, ethyl lactate, tetrahydrofuran, 2-methyltetrahydrofuran, water, phenol, acetone, or a combination thereof.

The crosslinking reagent used for casting the crosslinked membrane in the methods described herein can comprise 1,6-dibromohexane, 1,4-dibromobutane, 1,8-dibromooctane, 1,4-dibromohepane, 1,7-dibromohepane, 1,10-dibromodecane, 1,12-dibromododecane, 1,6-diiodohexane, 1,4-diiodobutane, 1,10-diiododecane, 1,5-diiodopentane, 1,8-diiodooctane, α,α′-dichloro-p-xylene, 4,4′-bis(chloromethyl)-1,1′-biphenyl, a cationic crosslinking reagent of formula (7) as described below, or any combination thereof.

The crosslinking reagent used for casting the crosslinked membrane in the methods described herein can comprise a cationic crosslinking reagent of formula (7):

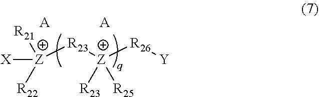

wherein:
A is an anion;
q is an integer from 1 to 100;
R₂₁, R₂₂, R₂₃, R₂₄, R₂₅ and R₂₆ are each independently alkyl or aryl;
X and Y are each independently Cl, Br or I; and
Z is N or P.

The base used in any of the above methods can comprise a hydroxide-containing base such as sodium hydroxide or potassium hydroxide; a bicarbonate-containing base such as sodium bicarbonate or potassium bicarbonate; or a carbonate-containing base such as sodium carbonate or potassium carbonate.

The alkylating agent used in the any of the methods described herein can comprise methyl iodide, iodoethane, 1-iodopropane, 1-iodobutane, 1-iodopentane, 1-iodohexane, methyl bromide, bromoethane, 1-bromopropane, methyl chloride, chloroethane, 1-chloropropane, methyl fluorosulfonate, methyl trifluoromethanesulfonate, or a combination of thereof.

A reinforced electrolyte membrane such as a reinforced anion exchange membrane is also provided to increase the mechanical robustness of the anion exchange membrane for stability through numerous wet and dry cycles. The reinforced membrane comprises a porous substrate impregnated with any of the anion exchange polymers as described herein. Methods for preparing reinforced membranes are well known to those of ordinary skill in the art such as those disclosed in U.S. Pat. Nos. RE37,656 and RE37,701, which are incorporated herein by reference for their description of reinforced membrane synthesis and materials.

A reinforced ion exchange membrane including any polymer membrane of the invention can be optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO₂ separator.

The porous substrate of the reinforced electrolyte membrane can comprise a membrane comprised of polytetrafluoroethylene, polypropylene, polyethylene, poly(ether) ketone, polyaryletherketone, imidazole-tethered poly(aryl alkylene), imidazolium-tethered poly(aryl alkylene), polysulfone, perfluoroalkoxyalkane, or a fluorinated ethylene propylene polymer, and the membrane is optionally a dimensionally stable membrane.

The porous substrate of the reinforced electrolyte membrane can have at least one of the following:
the porous substrate has a porous microstructure of polymeric fibrils;
   an interior volume of the porous substrate is rendered substantially occlusive by impregnation with the polymer;
the porous substrate comprises a microstructure of nodes interconnected by fibrils;
the porous substrate has a thickness from about 1 micron to about 100 microns;
the membrane is prepared by multiple impregnations of the substrate with the polymer; or
the membrane is prepared by: wetting the porous substrate in a liquid to form a wetted substrate; dissolving the polymer in a solvent to form a homogeneous solution or suspension;
applying the solution or suspension onto the wetted substrate to form the reinforced membrane; and drying the membrane.

The porous substrate can have a thickness from about 1 micron to about 10, 15, 20, 25, 30, 35, 40, 45, 50, 55, 60, 65, 70, 75, 80, 85, 90, 95 or 100 microns. Preferably, the porous substrate has a thickness from about 5 microns to about 30 microns, or from about 7 microns to about 20 microns.

### EXAMPLES

The following non-limiting examples are provided to further illustrate the present invention.

### Example 1

A non-crosslinked poly(aryl piperidinium) membrane was prepared from N-methyl-4-piperidone, p-terphenyl, biphenyl and 2,2,2-Trifluoroacetophenone. (referred to as P1-A-x, wherein x is the mole ratio of N-methyl-4-piperidone to the sum of 2,2,2-Trifluoroacetophenone and N-methyl-4-piperidone, and is from 0.01 to 0.99) P1-A-x was prepared by three major steps: (1) synthesis of a piperidine-functionalized polymer, (2) synthesis of a piperidinium-functionalized polymer, and (3) membrane casting and hydroxide ion exchange. The reaction scheme is depicted below:

(1) Synthesis of a Piperidine-Functionalized Polymer, P1-Nuetral-0.85 (i.e. x=0.85). To a 100 mL three-necked flask equipped with overhead a mechanical stirrer, N-methyl-4-piperidone (0.962 g, 8.5 mmol), 2,2,2-Trifluoroacetophenone (0.262 g, 1.5 mmol), p-terphenyl (1.152 g, 5 mmol) and biphenyl (0.771 g, 5 mmol) were suspended into methylene chloride (10 mL). Trifluoromethanesulfonic acid (TFSA) (10 mL) were then added dropwise over 30 minutes. Thereafter, the reaction was continued at 0° C. temperature for 12 hours. The resulting viscous solution was poured slowly into ethanol. The light-yellow fibrous solid was filtered, washed with water and immersed in 1 M KOH at room temperature for 12 hours. Finally, the white fibrous product was filtered, washed with water and dried completely at 60° C. under vacuum. The yield of the polymer was nearly 100%.

(2) Synthesis of Piperidinium-Functionalized Polymer, P1-Me-0.85. To a 50 mL one-necked flask equipped with magnetic bar, piperidine-functionalized polymer (1.0 g) was dissolved into 1-methyl-2-pyrrolidinone (10 mL). Methyl iodide (0.5 mL) was added to the mixture quickly. The solution was stirred over 12 hours at room temperature. The resulting viscous, yellow solution was added dropwise into ether. The yellow solid was filtered, washed with ether and dried completely at 60° C. under vacuum. The yield of the polymer P1-Me-0.85 was almost 100%.

(3) Membrane Casting and Hydroxide Exchange. A membrane was prepared by dissolving the P1-Me-0.85 polymer (1.0 g) in NMP (10 mL) and by casting on a clear glass plate at 80° C. for 8 hours. The membrane (in iodide form) was peeled off from the glass plate in contact with deionized (DI) water. The membrane in hydroxide form were obtained by ion exchange in 1 M KOH at 60° C. for 24 hours, followed by washing and immersing the membrane in DI water for 48 hours under argon to remove residual KOH.

Other P1-A-x membranes were prepared by using different mole ratios of N-methyl-4-piperidone to 2,2,2-Trifluoroacetophenone or/and different mole ratios between the biphenyl and p-terphenyl.

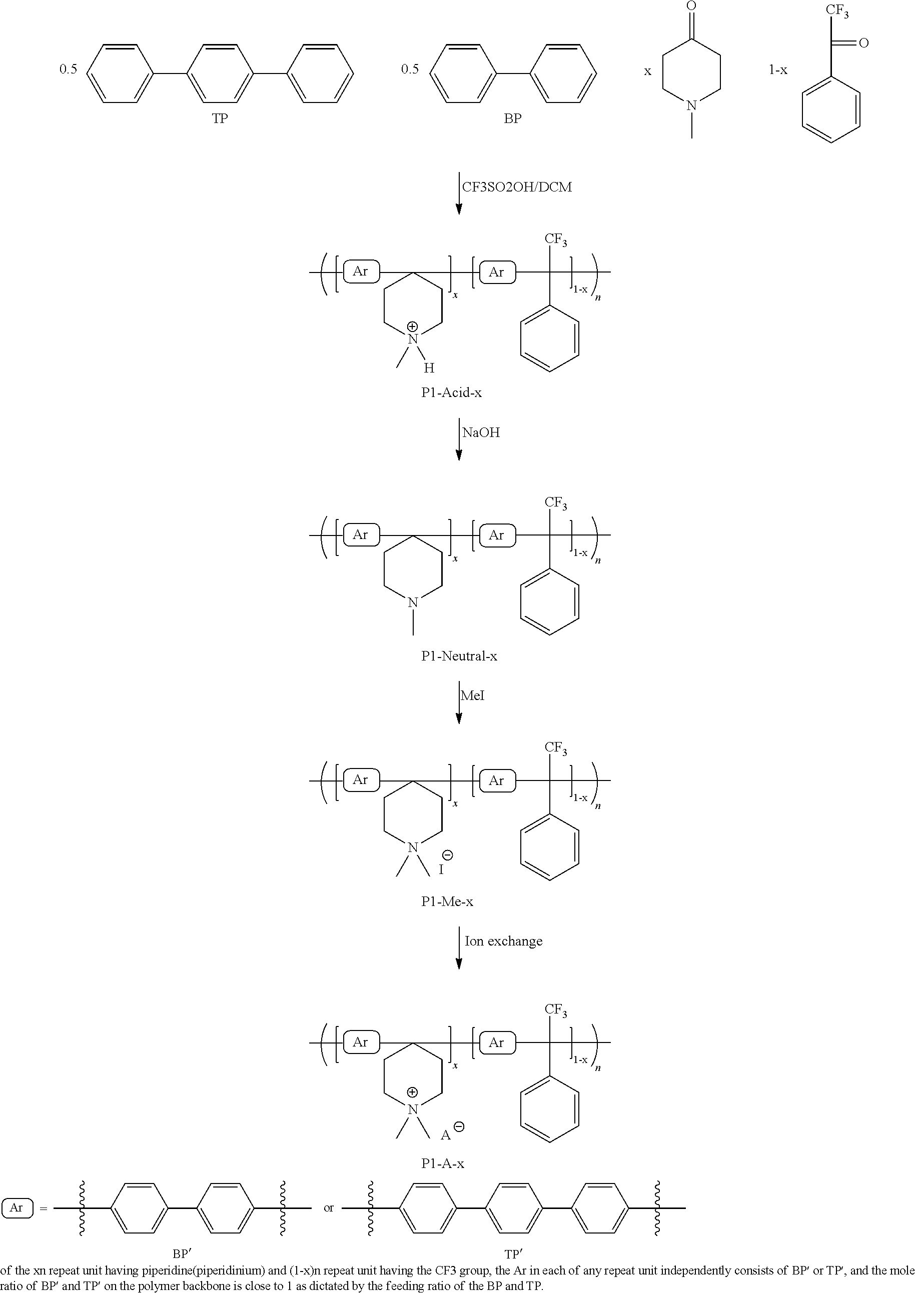

of the xn repeat unit having piperidine (piperidinium) and (1-x) n repeat unit having the CF3 group, the Ar in each of any repeat unit independently consists of BP′ or TP′, and the mole ratio of BP′ and TP′ on the polymer backbone is close to 1 as dictated by the feeding ratio of the BP and TP.
n is an integer from 1 to 1,000,000; x=0.01 to 0.99;
A⁻ is an anion, OH⁻, HCO₃_{^{−}}, Cl⁻, CO₃²⁻

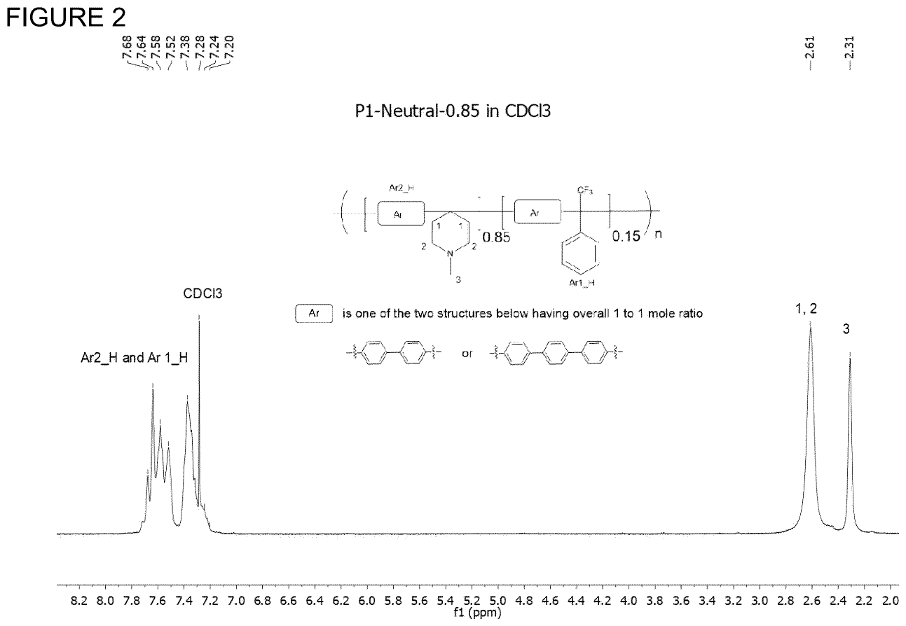

P1-Neutral-0.85 was obtained with a yield close to 98%, 1HNMR (CDCl3; δ, ppm): 7.20-7.68 (Ar1_H and Ar2_H, the protons on the aromatic rings), 2.61 (H1, H2), 2.31 (H3) (see FIG. 2).

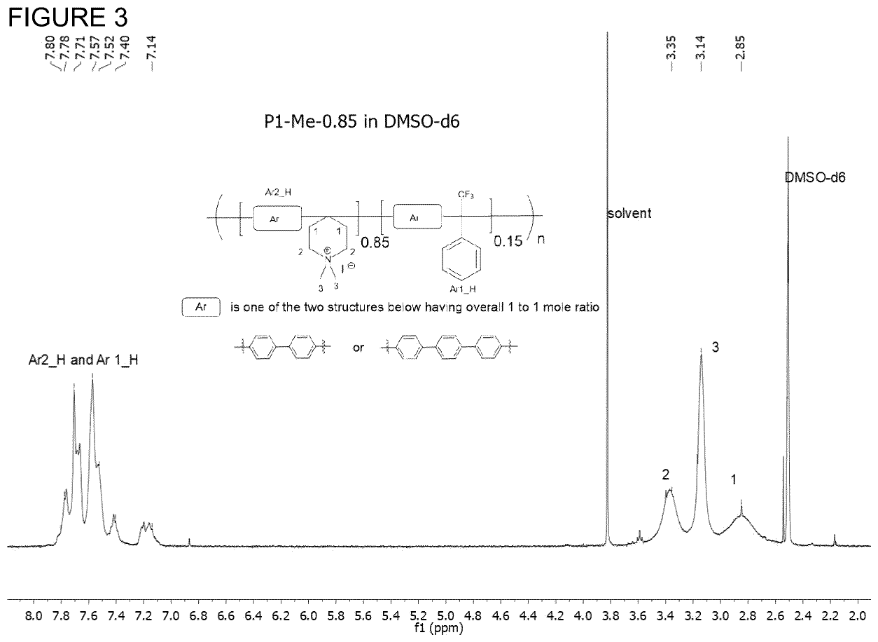

P1-Me-0.85 in DMSO-d6 was obtained with a yield close to 97%, ¹HNMR (DMSO-d₆; δ, ppm): 7.14-7.80 (Ar1_H and Ar2_H, the protons on the aromatic rings), 3.35 (H2), 3.14 (H3), 2.85 (H1) (see FIG. 3).

### Example 2: Crosslinked Polymer Based on the P1-Neutral-x Piperidine-Functionalized Polymer

A crosslinked poly(aryl piperidinium) referred to as P1-A-x(a)-XL (wherein x is the mole ratio of N-methyl-4-piperidone to the sum of 2,2,2-Trifluoroacetophenone and N-methyl-4-piperidone, and is from 0.01 to 0.99, a is the ratio of the partial quaternization) was prepared from P1-Neutral-x piperidine-functionalized polymer. P1-A-x(a)-XL was prepared by two major steps: (1) synthesis of a partially alkylated piperidinium-functionalized polymer P1-A-x(a), and (2) crosslinking of P1-A-x(a) to obtain P1-A-x(a)-XL. The reaction scheme is depicted below:

(1) Synthesis of the partially alkylated Piperidinium-Functionalized Polymer, P1-A-0.85 (0.75) (i.e. x=0.85, a=0.75). To a 50 mL one-necked flask equipped with magnetic bar, P1-Neutral-0.85 (1.0 g) was dissolved into 1-methyl-2-pyrrolidinone (10 mL). Methyl iodide (0.23 g) was added to the mixture quickly to partially alkylated the piperidine. The solution was stirred over 12 hours at room temperature. The resulting viscous, yellow solution was added dropwise into ether. The yellow solid was filtered, washed with ether, ion exchanged with 1M sodium bicarbonate and dried completely at 60° C. under vacuum. The yield of the polymer P1-A-0.85 (0.75) was almost 100%.

(2) Membrane Casting, P1-A-0.85 (0.75)-XL (i.e. x=0.85, a=0.75) The crosslinked membrane was prepared by dissolving the P1-A-0.85 (0.75) polymer (10.0 g) and 1,6-dibromohexane (0.51 g) in a solvent (100 mL) and by casting on a clear glass plate at 80° C. for 8 hours. The membrane was peeled off from the glass plate in contact with deionized (DI) water. The membrane in hydroxide form were obtained by ion exchange in 1 M KOH at 60° C. for 24 hours, followed by washing and immersing the membrane in DI water for 48 hours under argon to remove residual KOH.

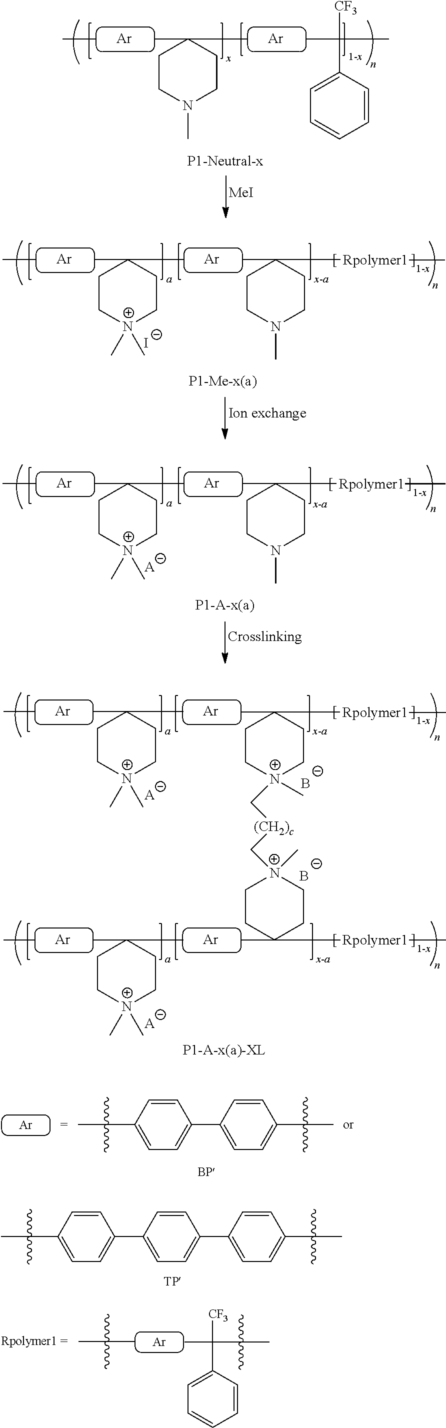

The Ar in each of any repeat unit independently consists of BP′ or TP′, and the mole ratio of BP′ and TP′ on the polymer backbone is close to 1 as dictated by the feeding ratio of the BP and TP.
n is an integer from 10 to 1,000,000; x=0.01 to 0.99; a=0.01 to 0.99, c=1 to 20;
A⁻ is an anion, OH⁻, HCO₃_{^{−}}, Cl⁻, CO₃²⁻
B⁻ is an anion, OH⁻, HCO₃_{^{−}}, Cl⁻, I⁻, CO₃²⁻

### Example 3

Polymers prepared from a mixture of biphenyl, p-terphenyl, N-methyl-4-piperidone, 2,2,2-Trifluoroacetophenone and isatin. The synthesis of the polymer is similar to the procedure described in example 1. The reaction scheme is depicted below.

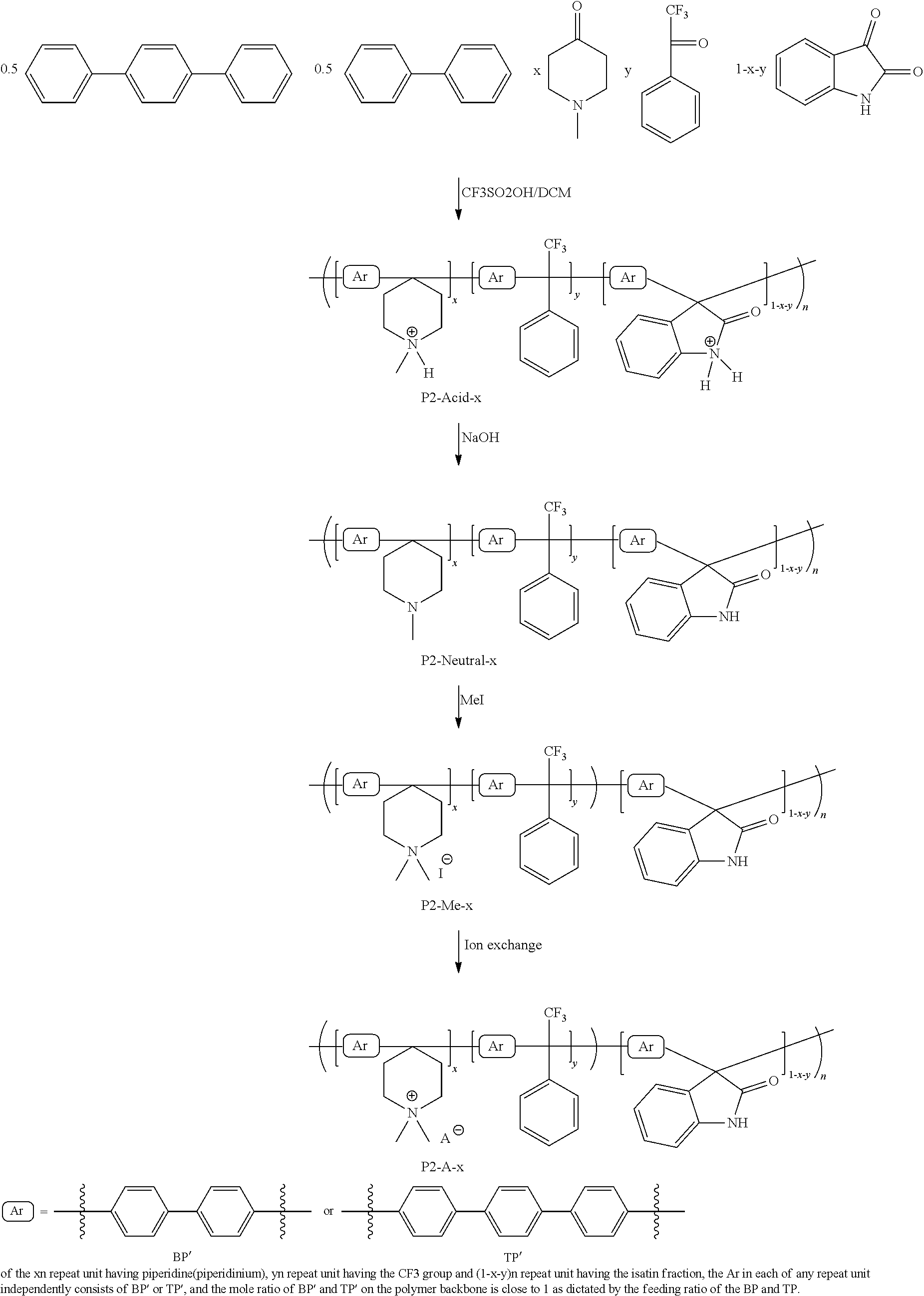

of the xn repeat unit having piperidine (piperidinium), yn repeat unit having the CF3 group and (1-x-y) n repeat unit having the isatin fraction, the Ar in each of any repeat unit independently consists of BP′ or TP′, and the mole ratio of BP′ and TP′ on the polymer backbone is close to 1 as dictated by the feeding ratio of the BP and TP.
n is an integer from 10 to 1,000,000; x=0.01 to 0.99, y=0.01 to 0.99
A⁻ is an anion, OH⁻, HCO₃_{^{−}}, Cl⁻, CO₃²⁻

### Example 4

The crosslinked membrane based on the P2-Neutral-x polymer is prepared in a way similar to that of example 2.

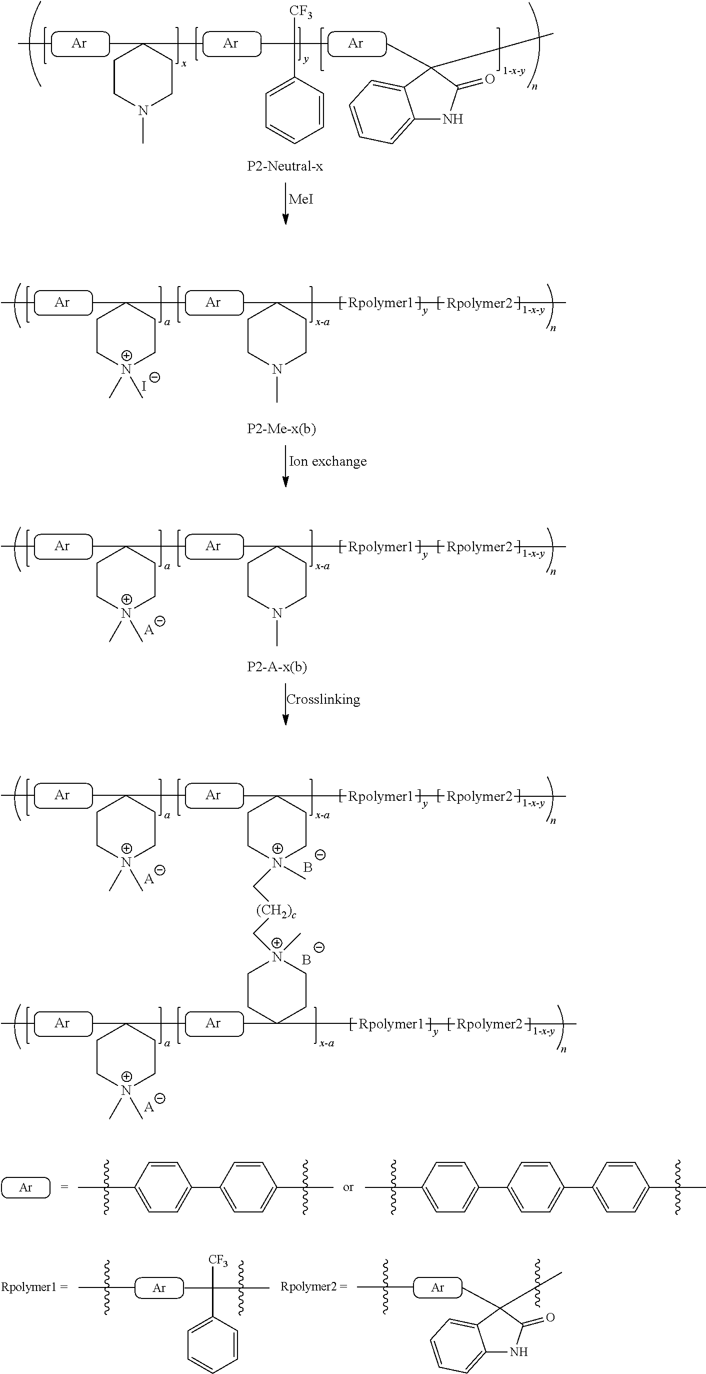

The Ar in each of any repeat unit independently consists of BP′ or TP′, and the mole ratio of BP′ and TP′ on the polymer backbone is close to 1 as dictated by the feeding ratio of the BP and TP.
n is an integer from 10 to 1,000,000
x=0.01 to 0.99; y=0.01-0.99; a=0.01 to 0.99; c=1 to 20
A⁻ is an anion, OH⁻, HCO₃_{^{−}}, Cl⁻, CO₃²⁻; B⁻ is an anion, OH⁻, HCO₃_{^{−}}, Cl⁻, CO₃²⁻

### Definitions

The term “suitable substituent,” as used herein, is intended to mean a chemically acceptable functional group, preferably a moiety that does not negate the activity of the inventive compounds. Such suitable substituents include, but are not limited to halo groups, perfluoroalkyl groups, perfluoroalkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C—O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxycarbonyl groups, alkylsulfonyl groups, and arylsulfonyl groups. Those skilled in the art will appreciate that many substituents can be substituted by additional substituents.

The term “alkyl,” as used herein, refers to a linear, branched or cyclic hydrocarbon radical, preferably having 1 to 32 carbon atoms (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons), and more preferably having 1 to 18 carbon atoms. Alkyl groups include, but are not limited to, methyl, ethyl, n-propyl, isopropyl, n-butyl, iso-butyl, secondary-butyl, and tertiary-butyl. Alkyl groups can be unsubstituted or substituted by one or more suitable substituents.

The term “alkenyl,” as used herein, refers to a straight, branched or cyclic hydrocarbon radical, preferably having 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons, more preferably having 1 to 18 carbon atoms, and having one or more carbon-carbon double bonds. Alkenyl groups include, but are not limited to, ethenyl, 1-propenyl, 2-propenyl (allyl), iso-propenyl, 2-methyl-1-propenyl, 1-butenyl, and 2-butenyl. Alkenyl groups can be unsubstituted or substituted by one or more suitable substituents, as defined above.

The term “alkynyl,” as used herein, refers to a straight, branched or cyclic hydrocarbon radical, preferably having 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons, more preferably having 1 to 18 carbon atoms, and having one or more carbon-carbon triple bonds. Alkynyl groups include, but are not limited to, ethynyl, propynyl, and butynyl. Alkynyl groups can be unsubstituted or substituted by one or more suitable substituents, as defined above.

The term “aryl” or “ar,” as used herein alone or as part of another group (e.g., aralkyl), means monocyclic, bicyclic, or tricyclic aromatic radicals such as phenyl, naphthyl, tetrahydronaphthyl, indanyl and the like; optionally substituted by one or more suitable substituents, preferably 1 to 5 suitable substituents, as defined above. The term “aryl” also includes heteroaryl.

Arylalkyl” or “aralkyl” means an aryl group attached to the parent molecule through an alkylene group. The number of carbon atoms in the aryl group and the alkylene group is selected such that there is a total of about 6 to about 18 carbon atoms in the arylalkyl group. A preferred arylalkyl group is benzyl.

The term “cycloalkyl,” as used herein, refers to a mono, bicyclic or tricyclic carbocyclic radical (e.g., cyclopropyl, cyclobutyl, cyclopentyl, cyclohexyl, cycloheptyl, cyclooctyl, cyclononyl, cyclopentenyl, cyclohexenyl, bicyclo[2.2.1]heptanyl, bicyclo[3.2.1]octanyl and bicyclo[5.2.0]nonanyl, etc.); optionally containing 1 or 2 double bonds. Cycloalkyl groups can be unsubstituted or substituted by one or more suitable substituents, preferably 1 to 5 suitable substituents, as defined above.

The term “-ene” as used as a suffix as part of another group denotes a bivalent radical in which a hydrogen atom is removed from each of two terminal carbons of the group, or if the group is cyclic, from each of two different carbon atoms in the ring. For example, alkylene denotes a bivalent alkyl group such as ethylene (—CH₂CH₂—) or isopropylene (—CH(CH₃)CH₂—). For clarity, addition of the -ene suffix is not intended to alter the definition of the principal word other than denoting a bivalent radical. Thus, continuing the example above, alkylene denotes an optionally substituted linear saturated bivalent hydrocarbon radical.

The term “hydrocarbon” as used herein describes a compound or radical consisting exclusively of the elements carbon and hydrogen.

The term “polycycle” as used herein describes a compound or radical having two or more hydrocarbon rings which can be substituted with heteroatom(s) such as nitrogen or oxygen. The polycycle can be aromatic or non-aromatic.

The term “substituted” means that in the group in question, at least one hydrogen atom bound to a carbon atom is replaced with one or more substituent groups such as hydroxy (—OH), alkylthio, phosphino, amido (—CON(RA)(RB), wherein RA and RB are independently hydrogen, alkyl, or aryl), amino (—N(RA)(RB), wherein RA and RB are independently hydrogen, alkyl, or aryl), halo (fluoro, chloro, bromo, or iodo), silyl, nitro (—NO2), an ether (—ORA wherein RA is alkyl or aryl), an ester (—OC(O)RA wherein RA is alkyl or aryl), keto (—C(O)RA wherein RA is alkyl or aryl), heterocyclo, and the like. When the term “substituted” introduces or follows a list of possible substituted groups, it is intended that the term apply to every member of that group. That is, the phrase “optionally substituted alkyl or aryl” is to be interpreted as “optionally substituted alkyl or optionally substituted aryl.” Likewise, the phrase “alkyl or aryl optionally substituted with fluoride” is to be interpreted as “alkyl optionally substituted with fluoride or aryl optionally substituted with fluoride.”

The term “tethered” means that the group in question is bound to the specified polymer backbone. For example, an imidazolium-tethered poly (aryl alkylene) polymer is a polymer having imidazolium groups bound to a poly (aryl alkylene) polymer backbone.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved, and other advantageous results attained.

As various changes could be made in the above products and methods without departing from the scope of the invention, it is intended that all matter contained in the above description and shown in the accompanying drawings shall be interpreted as illustrative and not in a limiting sense.

1. An anion exchange polymer comprising:
structural units of formulae 1A, at least two of formulae 2A, 2A-2, 3A, and 3A-2, and one of formulae 4A, 5A, 5A-2, and 6A; or
structural units of formulae 1A, at least two of formulae 2A, 2A-2, 3A, and 3A-2, and at least two of formulae 4A, 5A, 5A-2, and 6A;
wherein:
a sum of mole fractions of the structural units of formulae 1A, 4A, 5A, 5A-2 and 6A is equal to a sum of mole fraction of formula 2A, 2A-2, 3A and 3A-2 in the polymer calculated from an amount of monomers used in a polymerization reaction to form the polymer, and a mole ratio of the structural unit of Formula 1A to the structural unit of Formula 4A or 5A or 5A-2 or 6A is from 0.01 to 100 calculated from the amount of monomers used in the polymerization reaction, and a mole ratio between the structural unit of formula of 2A, 2A-2, 3A, 3A-2 is from 0.01 to 100 calculated from the amount of monomers used in the polymerization reaction; and
the structural units of Formulae 1A, 2A, 2A-2, 3A, 3A-2 4A, 5A, 5A-2 and 6A have the structures: 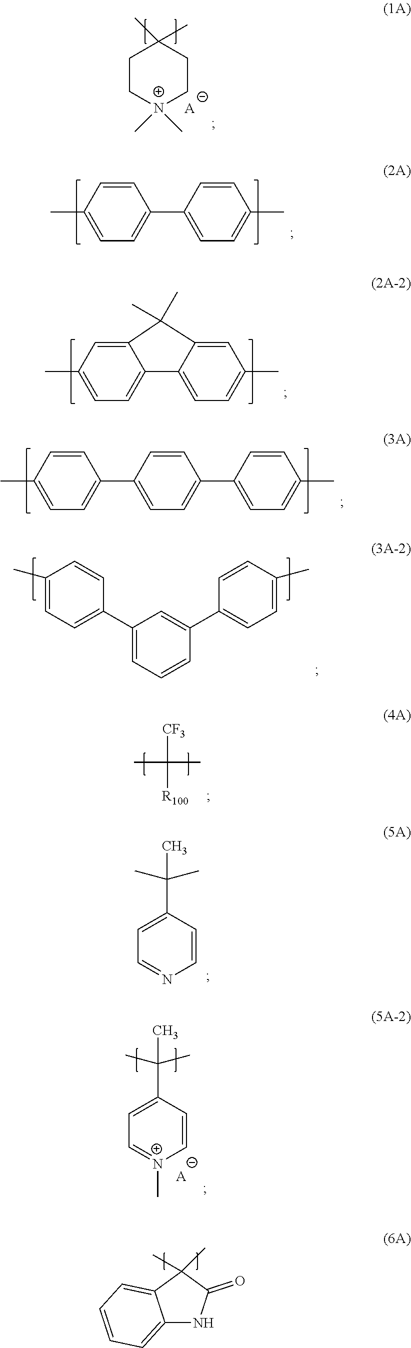
wherein:
A⁻ is an anion;
R₁₀₀ is independently alkyl, alkenyl, alkynyl, or 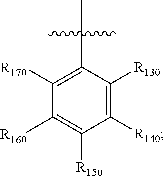
and
R₁₃₀, R₁₄₀, R₁₅₀, R₁₆₀ and R₁₇₀ are each independently hydrogen, halide, alkyl, alkenyl, alkynyl or aryl, and the alkyl, alkenyl, alkynyl or aryl are optionally substituted with halide.

2. An anion exchange polymer comprising a reaction product of a polymerization mixture comprising:
a piperidone monomer or salt or hydrate thereof of formula 1, at least two of aromatic monomers of formulae 2, 2-2, 3, and 3-2, and one of ketone monomers of formulae 4, 5, and 6; or
a piperidone monomer or salt or hydrate thereof of formula 1, at least two of the aromatic monomers of formula 2, 2-2, 3, and 3-2, and at least two of the ketone monomers of formula 4, 5, and 6;
wherein:
(i) the piperidone monomer or salt or hydrate thereof has the formula: 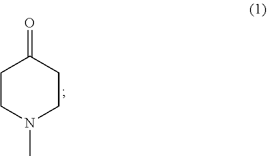
(ii) the aromatic monomers have the formula: 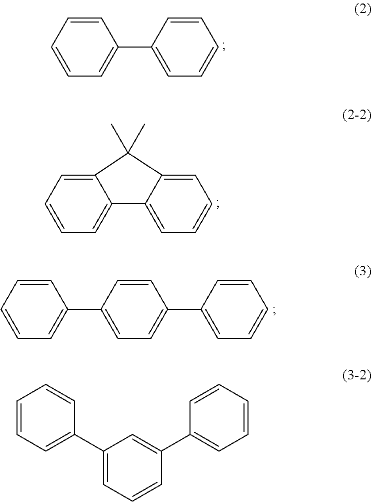
(iii) the ketone monomers have the formula: 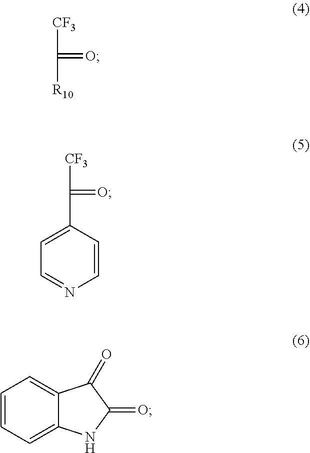
wherein:
R₁₀ is independently alkyl, alkenyl, alkynyl, or 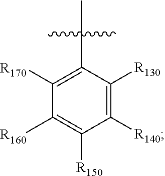
and
R₁₃₀, R₁₄₀, R₁₅₀, R₁₆₀ and R₁₇₀ are each independently hydrogen, halide, alkyl, alkenyl, alkynyl or aryl, and the alkyl, alkenyl, alkynyl or aryl are optionally substituted with halide.

3. A polymer comprising a reaction product of a base and the polymer of claim 2.

4. A polymer comprising a reaction product of an alkylating agent and the polymer of claim 3.

5. A partially alkylated polymer comprising a reaction product of an alkylating agent and the polymer of claim 3.

6. A crosslinked polymer comprising a reaction product of a crosslinking reagent and the polymer of claim 5.

7. A polymer comprising a reaction product of the polymer of claim 1, and a solution of halide, hydroxide, bicarbonate, or carbonate ions or a combination thereof.

8. The polymer of claim 4, wherein the alkylating agent comprises methyl iodide, iodoethane, 1-iodopropane, 1-iodobutane, 1-iodopentane, 1-iodohexane, methyl bromide, bromoethane, 1-bromopropane, methyl chloride, chloroethane, 1-chloropropane, methyl fluorosulfonate, methyl trifluoromethanesulfonate or a combination thereof.

9. The polymer of claim 1, wherein A⁻ comprises a halide, carbonate, bicarbonate, hydroxide, trifluoroacetate, acetate, triflate, methanesulfonate, sulfate, nitrate, tetrafluoroborate, hexafluorophosphate, formate, benzenesulfonate, toluate, perchlorate, or benzoate or any combination thereof.

10. The polymer of claim 2, wherein in the ketone monomers R₁₀ is each independently alkyl, alkenyl, or alkynyl, and the alkyl, alkenyl or alkynyl are optionally substituted with fluoride.

11. The polymer of claim 2, wherein in the ketone monomers R₁₀ is each independently methyl, ethyl, propyl, butyl, pentyl, or hexyl.

12. The polymer of claim 2, wherein in the ketone monomers R₁₀ is independently 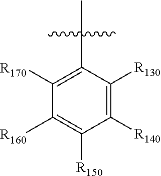
and R₁₃₀, R₁₄₀, R₁₅₀, R₁₆₀ and R₁₇₀ are each independently hydrogen, halide, alkyl, alkenyl, alkynyl or aryl, and the alkyl, alkenyl, alkynyl or aryl are optionally substituted with halide.

13. The polymer of claim 2, wherein the salt of the piperidone monomer comprises N-methyl-4-piperidone hydrofluoride, N-methyl-4-piperidone hydrochloride, N-methyl-4-piperidone hydrobromide, N-methyl-4-piperidone hydroiodide, N-methyl-4-piperidone trifluoroacetate, N-methyl-4-piperidone tetrafluoroborate, N-methyl-4-piperidone hexafluorophosphate, N-methyl-4-piperidone acetate, N-methyl-4-piperidone triflate, N-methyl-4-piperidone methanesulfonate, N-methyl-4-piperidone formate, N-methyl-4-piperidone benzenesulfonate, N-methyl-4-piperidone toluate, N-methyl-4-piperidone sulfate, N-methyl-4-piperidone nitrate, N-methyl-4-piperidone perchlorate, N-methyl-4-piperidone benzoate or any hydrate of the salt, or any combination thereof.

14. A method of making an anion exchange polymer of claim 2, the method comprising:
reacting the piperidone monomer with the aromatic monomers and the ketone monomer in the presence of an organic solvent and a polymerization catalyst to form an acidified intermediate polymer;
reacting the acidified intermediate polymer with a base to form a neutralized polymer;
alkylating the neutralized polymer in the presence of an organic solvent to form a piperidinium-functionalized polymer; and
reacting the piperidinium-functionalized polymer with halide, hydroxide, bicarbonate, or carbonate ions or a combination thereof to form the anion exchange polymer.

15. A method of making an anion exchange membrane from an anion exchange polymer of claim 2, the method comprising:
reacting the piperidone monomer with the aromatic monomers and the ketone monomer in the presence of an organic solvent and a polymerization catalyst to form an acidified intermediate polymer;
reacting the acidified intermediate polymer with a base to form a neutralized polymer;
alkylating the neutralized polymer in the presence of an organic solvent to form a piperidinium-functionalized polymer;
reacting the piperidinium-functionalized polymer with halide, hydroxide, bicarbonate, or carbonate ions or a combination thereof to form the anion exchange polymer;
dissolving the anion exchange polymer in a solvent to form a polymer suspension or solution;
casting the polymer suspension or solution to form the anion exchange polymer membrane.

16. A method of making a crosslinked anion exchange polymer comprising the anion exchange polymer of claim 2, the method comprising:
reacting the piperidone monomer with the aromatic monomers and the ketone monomer in the presence of an organic solvent and a polymerization catalyst to form an acidified intermediate polymer;
reacting the acidified intermediate polymer with a base to form a neutral piperidine-functionalized polymer;
partially alkylating the neutral piperidine-functionalized polymer with an alkylating agent to form a partially alkylated piperidinium-functionalized polymer having piperidine groups available for crosslinking;
reacting the partially alkylated piperidinium-functionalized polymer with a crosslinking reagent to form a crosslinked polymer;
optionally reacting the crosslinked polymer with trimethyl amine to alkylate partially reacted crosslinking reagent; and
reacting the crosslinked polymer with halide, hydroxide, bicarbonate, or carbonate ions or a combination thereof.

17. A method of making a crosslinked anion exchange membrane comprising the anion exchange polymer of claim 2, the method comprising:
reacting the piperidone monomer with the aromatic monomers and the ketone monomer in the presence of an organic solvent and a polymerization catalyst to form an acidified intermediate polymer;
reacting the acidified polymer with a base to form neutral piperidine-functionalized polymer;
partially alkylating the neutral piperidine-functionalized polymer with an alkylating agent to leave part of the neutral piperidine intact for crosslinking;
reacting the partially alkylated piperidinium-functionalized polymer with halide, hydroxide, bicarbonate, or carbonate ions or a combination thereof to form the anion exchange polymer;
dissolving the anion exchange polymer in a solvent to form a polymer suspension or solution;
adding a crosslinking reagent to the polymer suspension or solution and casting to form the crosslinked anion exchange polymer membrane; and
optionally reacting the crosslinked anion exchange polymer membrane with trimethyl amine to alkylate partially reacted crosslinking reagent.

18. The method of claim 14, wherein the polymerization catalyst comprises trifluoromethanesulfonic acid, pentafluoroethanesulfonic acid, heptafluoro-1-propanesulfonic acid, trifluoroacetic acid, perfluoropropionic acid, heptafluorobutyric acid, or a combination thereof.

19. The method of claim 3, wherein the base comprises sodium hydroxide, potassium hydroxide, sodium bicarbonate, potassium bicarbonate, or a combination thereof.

20. The method of claim 14, wherein the organic solvent comprises dimethyl sulfoxide, 1-methyl-2-pyrrolidone, dimethylacetamide, dimethylformamide, methylene chloride, trifluoroacetic acid, trifluoromethanesulfonic acid, chloroform, 1,1,2,2-tetrachloroethane, dimethylacetamide or a combination thereof.

21. The method of claim 15, wherein the membrane is cast in the presence of methanol, ethanol, n-propanol, isopropanol, n-butanol, sec-butanol, tert-butanol, a pentanol, a hexanol, dimethyl sulfoxide, 1-methyl-2-pyrrolidone, dimethylformamide, dimethylacetamide, chloroform, ethyl lactate, tetrahydrofuran, 2-methyltetrahydrofuran, water, phenol, acetone, or a combination thereof.

22. The method of claim 6, wherein the crosslinking reagent comprises 1,4-dibromobutane, 1,6-dibromohexane, 1,8-dibromooctane, 1,4-dibromohepane, 1,7-dibromohepane, 1,10-dibromodecane, 1,12-dibromododecane, 1,6-diiodohexane, 1,4-diiodobutane, 1,10-diiododecane, 1,5-diiodopentane, 1,8-diiodooctane, α,α′-dichloro-p-xylene, 4,4′-bis(chloromethyl)-1,1′-biphenyl, a cationic crosslinking reagent of formula 7, or any combination thereof, wherein the cationic crosslinking reagent has the formula: 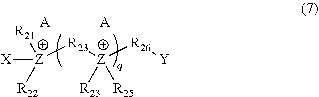
wherein:
A is an anion;
q is an integer from 1 to 100;
R₂₁, R₂₂, R₂₃, R₂₄, R₂₅ and R₂₆ are each independently alkyl or aryl;
X and Y are each independently Cl, Br or I; and
Z is N or P.

23. An anion exchange membrane configured and sized to be suitable for use in a fuel cell, electrolyzer, electrodialyzer, solar hydrogen generator, flow battery, desalinator, sensor, demineralization of water, ultra-pure water production, wastewater treatment, ion exchanger, or CO2 separator, and comprising the polymer of claim 1.

24. An anion exchange membrane fuel cell, electrolyzer, electrodialyzer, solar hydrogen generator, flow battery, desalinator, sensor, demineralization of water, ultra-pure water production, wastewater treatment, ion exchanger, or CO2 separator comprising the polymer of claim 1.

25. A reinforced ion exchange membrane or electrolyte membrane, optionally configured and sized to be suitable for use in a fuel cell, electrolyzer, electrodialyzer, solar hydrogen generator, flow battery, desalinator, sensor, demineralizer, water purifier, wastewater treatment system, ion exchanger, or CO2 separator, the reinforced membrane comprising a porous substrate impregnated with the polymer of claim 1.

26. The membrane of claim 25, wherein the porous substrate comprises a membrane comprised of polytetrafluoroethylene, polypropylene, polyethylene, poly(ether) ketone, polyaryletherketone, imidazole-tethered poly(aryl alkylene), imidazolium-tethered poly(aryl alkylene), polysulfone, perfluoroalkoxyalkane, or a fluorinated ethylene propylene polymer, and the membrane is optionally a dimensionally stable membrane.

27. The membrane of claim 25, wherein either:
the porous substrate has a porous microstructure of polymeric fibrils;
an interior volume of the porous substrate is rendered substantially occlusive by impregnation with the polymer;
the porous substrate comprises a microstructure of nodes interconnected by fibrils;
the porous substrate has a thickness from about 1 micron to about 100 microns;
the membrane is prepared by multiple impregnations of the substrate with the polymer; or
the membrane is prepared by:
wetting the porous substrate in a liquid to form a wetted substrate;
dissolving the polymer in a solvent to form a homogeneous solution or suspension;
applying the solution or suspension onto the wetted substrate to form the reinforced membrane; and
drying the membrane.
